(19) United States
(12) Patent Application Publication
(10) Pub. No.: US 2008/0259158 A1
(43) Pub. Date: Oct. 23, 2008

(54) Video Surveillance System Controller

(76) Inventors: Tony Flint, Eagle Farm (AU); Peter Simpson, Eagle Farm (AU); Ross Cruickshank, Eagle Farm (AU)

Correspondence Address: GALLAGHER & DAWSEY CO., L.P.A., P.O. BOX 785, COLUMBUS, OH, 43216, US

(21) Appl. No.: 11/814,926

(22) PCT Filed: Jan. 31, 2006
(86) PCT No.: PCT/AU2006/000113

§ 371 Date: Apr. 18, 2008

(30) Foreign Application Priority Data
Jan. 31, 2005 (AU) 2005900391

(51) Int. Cl. H04N 7/18; G06F 3/033

(52) U.S. Cl. 348/143; 345/161; 348/E07.085

(57) ABSTRACT

A video surveillance system controller that controls multiple cameras with at least two joysticks (2, 3) and a keypad (4) to enable live queuing of the cameras. Each joystick (2, 3) independently controls a camera selected by the keypad (4). The keypad (4) can also select one of a number of monitors for displaying the view from a selected camera. The controller has a number of output ports that are configurable for different camera protocols, alarms and other external devices. Each joystick (2, 3) has at least two-axis control, for example, pan and tilt of a camera. The joystick (2, 3) may be three-axis to control pan, tilt and drive or four-axis to control pan, tilt, zoom and drive, or other control combinations.

This invention relates to a video surveillance system controller. In particular, it relates to controller utilising two joysticks to independently control two or more video surveillance cameras simultaneously.

### BACKGROUND TO THE INVENTION

It is well known to use video cameras to monitor sensitive regions, such as shopping centres, public places, defense installations, etc. The cameras are commonly static with a fixed field of view which is displayed on a screen for monitoring by security personnel. This arrangement provides very limited coverage so many installations use cameras that are fixed within a dome and can be rotated about a vertical axis (pan) or a horizontal axis (tilt) to direct the field of view at a desired scene. The scene selection may be determined manually by an operator but it is more common for the camera to automatically switch between a number of preset positions.

For larger installations the number of fixed view cameras becomes expensive and difficult to monitor. Movable camera systems have been developed that allow a camera to travel along a track, as well as pan and tilt, to provide a large coverage area with a relatively small number of cameras. As the number of cameras increases the complexity of controlling the position, zoom and focus of each camera increases dramatically.

A number of companies have developed specialised controllers to make operation of cameras easier thereby allowing a single operator to control multiple cameras and hence monitor multiple fields of view, thus effectively providing security over a large area with a small number of security personnel. Many of these controllers employ a keypad and joystick for camera control.

One such controller is described in U.S. Pat. No. 5,517,236 assigned to Philips Electronics North America Corporation. This patent describes a video surveillance system that has multiple dome cameras and multiple video monitors. A single controller is used to select a camera and monitor combination. A joystick on the controller allows the operator to pan and tilt the camera.

The system described in U.S. Pat. No. 5,517,236 employs cameras in fixed locations, so there is no need to control the movement of the cameras along a track. Recently systems have become commercially available which control movable cameras with a similar type of controller. One such example is a controller produced by TEB of France. The TEB controller incorporates a keypad and two joysticks. Each joystick is a two-axis controller. One joystick provides the normal pan and tilt control of the camera and the other joystick provides speed and direction control for moving the camera. The keypad allows selection of a camera and display on a video monitor.

Most producers of cameras employ proprietary protocols for control of the cameras. Thus a user is locked into a supplier after installing a surveillance system. This can be problematic since a particular installation may require a range of camera features that are not available from a single supplier. The problem has been addressed in a model DCJ controller produced by Videotec, an Italian company. The model DCJ controller can control a range of dome cameras from different suppliers, but it only incorporates a single joystick with conventional pan/tilt/zoom control.

### OBJECT OF THE INVENTION

It is an object of the present invention to provide a controller incorporating two joysticks for independently controlling two separate cameras, at the same time.

Further objects will be evident from the following description.

### DISCLOSURE OF THE INVENTION

In one form, although it need not be the only or indeed the broadest form, the invention resides in a controller for a video surveillance system having multiple cameras, the controller comprising:

at least two joysticks, each joystick having at least two-axis control;

a keypad;

one or more output ports in communication with two or more cameras; and

a processor receiving input signals from said keypad and said at least two joysticks and sending output signals to at least one of said one or more output ports to control two of said multiple cameras simultaneously.

Preferably each joystick is a three-axis joystick and movement of the joystick is translated to control pan, tilt and drive of one of the two of said multiple cameras.

Each output port may be configured for a communications protocol suitable for video cameras in communication with the port.

Suitably the controller further includes storage means that stores one or more default positions and views for each camera. The controller suitably positions each non-active camera at a default position and view determined by which of said multiple cameras are actively controlled by said joysticks.

### BRIEF DETAILS OF THE DRAWINGS

To assist in understanding the invention preferred embodiments will now be described with reference to the following figures in which:

FIG. 1 is a sketch of a controller for a video surveillance system;

FIG. 2 is a block schematic diagram of the controller of FIG. 1;

FIG. 3 depicts a mode of operation of the controller of FIG. 1 in a video surveillance system; and

FIG. 4 is a flowchart of the operation of the controller.

### DETAILED DESCRIPTION OF THE DRAWINGS

In describing different embodiments of the present invention common reference numerals are used to describe like features.

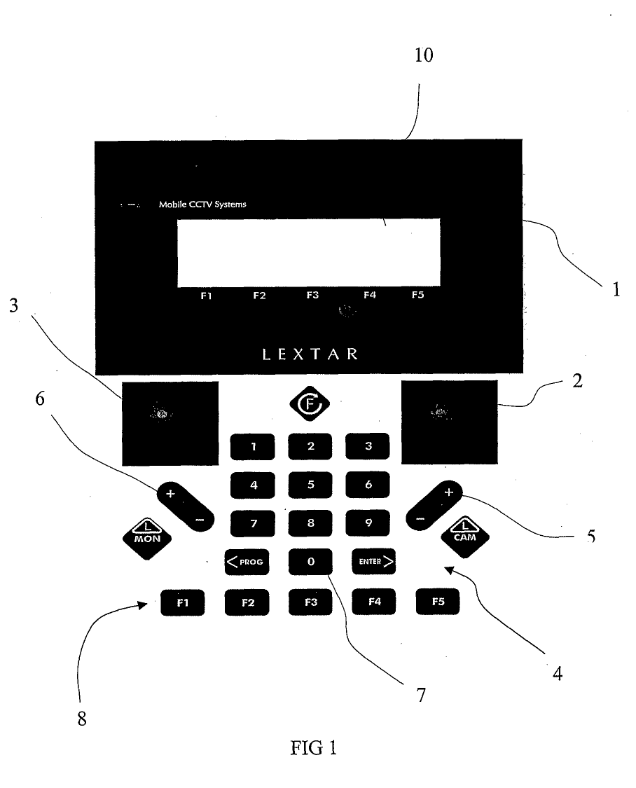

Referring to FIG. 1 there is shown a controller 1 for a video surveillance system of the type having multiple cameras each able to be independently positioned along a track. The controller 1 comprises a first joystick 2 that controls the pan, tilt and drive of a first camera and a second joystick 3 that controls the pan, tilt and drive of a second camera.

A keypad 4 is used for a range of functions including camera selection, monitor selection, set-up, and special functions. The keypad 4 includes +/−button 5 below the first joystick 2 that may be configured to adjust the zoom, focus or iris of the first camera. Similarly, the +/−button 6 below the second joystick 3 adjusts the zoom, focus or iris of the second camera.

It will be appreciated that the particular function allocated to each control element may be reconfigured to suite a user or particular application. For example, the joystick may be configured to control pan, zoom and drive if tilt is considered to be less important. Furthermore, the joystick may be a four axis device with drive being allocated to forward/backward motion of the joystick, pan being allocated to left/right motion, tilt being allocated to up/down motion and zoom being allocated to rotation of the joystick.

The keypad 4 includes keys for general use, such as the numeric keys 7, as well as specific keys, such as the MON key and the CAM key. The MON and CAM keys are used by the operator to select the active cameras and to direct the image to a particular monitor. The <PROG and ENTER> keys have dual function. They are used to set up the controller and in operating mode they select the primary (active) camera of the two cameras being controlled. During operation each joystick controls a camera but for advanced feature, such as tours and presets, the camera being automatically controlled must be selected. The camera to be automatically controlled is selected to the camera associated with the left joystick by <PROG or the right joystick by ENTER>.

A series of function keys 8 provide easy access to a range of advanced features/operations, such as the tours and presets referred to above.

The controller is menu driven with instructions displayed on the screen 10, which is suitably an LCD. The screen displays the keystrokes and the result.

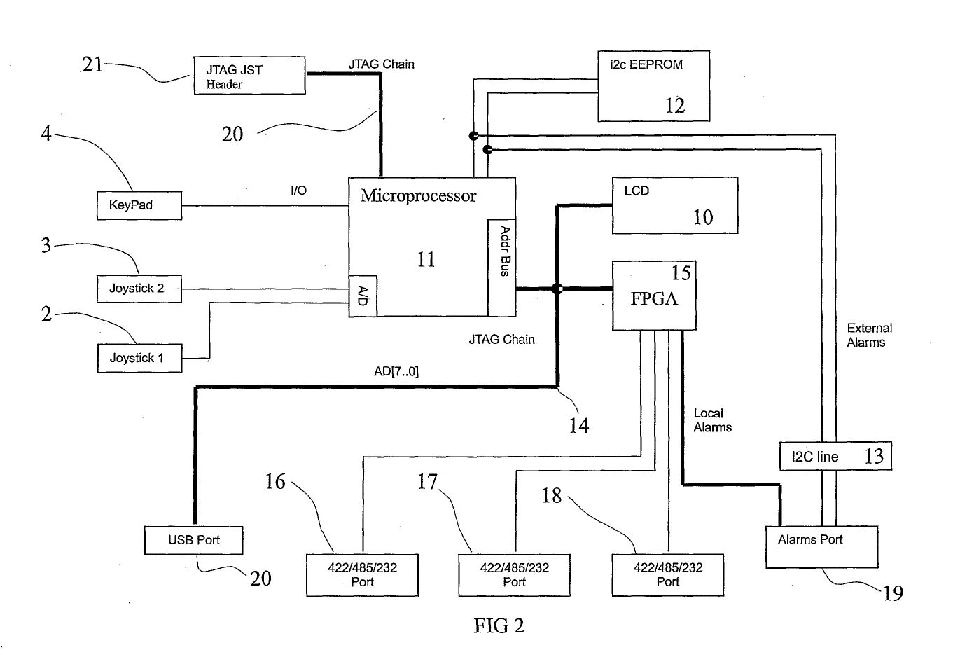

A schematic block diagram of the controller of FIG. 1 is shown in FIG. 2. At the heart of the controller 1 is a microprocessor 11 such as a □PSD (Programmable System Device with processor, on-board flash ROM and RAM) from ST Electronics. The microprocessor 11 accepts input directly from the keypad 4 to an I/O pin whereas the joysticks 2, 3 require an analog to digital conversion. The preferred microprocessor 11 has on-board A to D for this purpose. An I²C EEPROM 11 provides storage for preset, tour and alarm information as described below. An I²C line driver 13 provides an interface to a proprietary alarm panel that allows up to 224 alarms. The direct connection from a field programmable gate array (FPGA) 15 only allows eight alarms.

The microprocessor 11 generates output on an address bus 14 which drives the LCD 10 and communicates with FPGA 15 to address the camera ports 16, 17, 18 and the alarm port 19. The address bus 14 is also accessible via a USB port 20 for external processing. Each port has appropriate buffers and drivers as is well known to persons skilled in the field.

There may be multiple cameras connected to each camera port, 16, 17, 18 as described below. The output from active cameras will normally be displayed directly to a monitor. However, in more complex installations it may be appropriate to use a multiplexer to direct selected output to a selected monitor. Each port 16, 17, 18 is configurable to connect to a camera, a camera bus, a monitor multiplexer, a keyboard (for a master/slave configuration) or an external interface system to allow remote control by a computer. The computer interface has particular application in complex installations where the computer maintains a layout of the area being monitored, most usually a building. The ports are configured through the menu displayed on the LCD 10.

In the preferred embodiment of FIG. 1 and FIG. 2, the joysticks are conventional three-axis devices but could also be two-axis or four-axis joysticks. The three camera ports are suitably DB9 connectors and the associated drivers implement the RS232/422/485 protocols. Other connectors and protocols would also be suitable but the inventors have found that most existing cameras can be controlled with this configuration.

The alarm port 19 is suitably a DB15 connector but can have virtually any output configuration.

The microprocessor 11 and FPGA 15 are connected by a jtag chain 20 and may be programmed by an external PC accessing via the jst box header 21.

As discussed above by reference to FIG. 2, the controller has three ports to which cameras can be installed. Each port may utilize a different communication protocol so that cameras from different suppliers can be controlled from the one controller. Each camera is addressed according to the port number and a camera address. For example, a video surveillance system may have twenty cameras from three different suppliers. These cameras will be selectable at the controller as cameras #1 to #20. However cameras #1 to #5 may be addressed as Port 1 Camera 1 to Port 1 Camera 5. The next nine may be Port 2 Camera 1 to Port 2 Camera 9 and cameras #15 to #20 may be addressed as Port 3 Camera 1 to Port 3 Camera 6. The association of an individual camera with specific port/camera address occurs during set-up when an additional camera is added to the system.

Because the handling of communication protocols occurs within the controller a user can control any two cameras simultaneously from the one controller, whether they are on the same port or different ports and whether they have the same or different communication protocol. This allows a user to concentrate a primary camera on a scene while cueing another camera to a completely unrelated scene. It also allows a primary camera to be directed to a target (such as a likely shoplifter) while cueing a nearby camera to view the same target from a different angle. This latter capability is particularly useful for moving targets which must be handed over from one camera to the next.

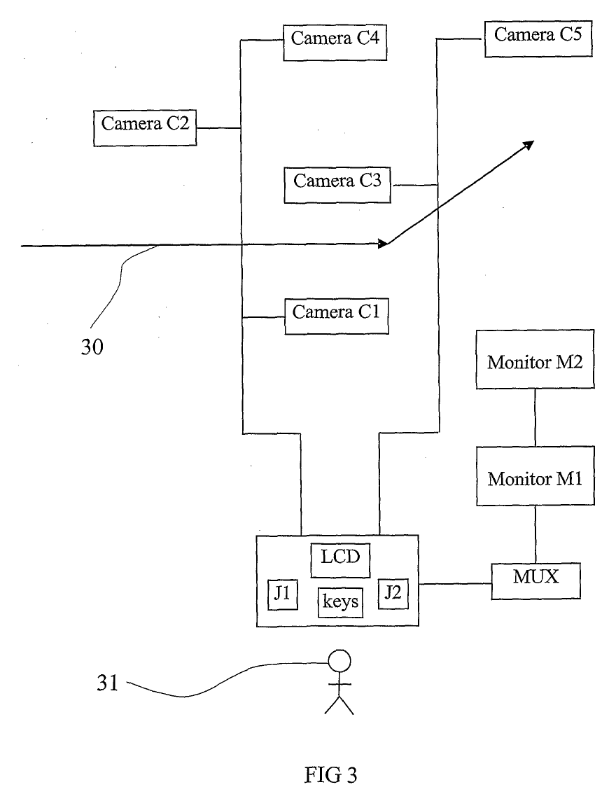

The operation of the controller to track a moving target is shown conceptually in FIG. 3. A target that follows the path indicated as 30, will initially be best viewed with camera C2 which may be displayed on monitor M1. The User 31 uses the keypad 4 to associate camera C2 with joystick J1 and to display the view on monitor M1. The key strokes to associate camera C2 with joystick 1 are press [ENTER>] to select the right joystick, press [2] press [CAM]. The image will go to the active monitor by default. To send the image to monitor M1 the keystrokes are press [1] and press [MON]. As the target 30 moves the User 31 tracks the target using joystick J1 to control pan, tilt and drive of camera C2. When camera C3 can view the target the User 31 cues camera C3 to monitor M2 and joystick J2 by pressing [<PROG] to make joystick J2 active then pressing [2] [CAM] and [2] [MON]. The User 31 will then reallocate joystick J1 to control camera C5 and assign the camera view to a suitable monitor.

Although only five cameras and two monitors are shown in FIG. 3 it will be appreciated that there can be many cameras and monitors but the procedure will not change. However, as the number of cameras increases the complexity of tracking a target and cueing the next camera can make the task difficult.

In a further embodiment of the invention the controller is programmed to automatically position each camera to a default position and view. The default position and view of each camera is determined in relation to adjoining active cameras. Because each camera will have multiple adjoining cameras there will be different default positions and views depending on which cameras are active, either as a tracking camera or a cueing camera. The default positions and views are programmed into the controller or stored when new cameras are added to the video surveillance system. The functionality is activated by one of the function keys 8 on the keypad 4.

The default positions and views are suitably contained in a look-up table. The look-up table can also be useful to assist the user with handover from one camera to the next when tracking a moving target. In a variation of the further embodiment described above, the controller automatically cues the most suitable camera. This can be overridden by the user.

The automatic positioning system reduces the amount of camera view positioning needed when cueing or fine tuning camera views while tracking a moving target as the view is already broadly positioned. Furthermore, modern digital recording systems allow the views from multiple cameras to be recorded simultaneously. By automatically adjusting the position and view of each camera according to the active cameras the best possible views are recorded and the system is more likely to capture/record relevant activity.

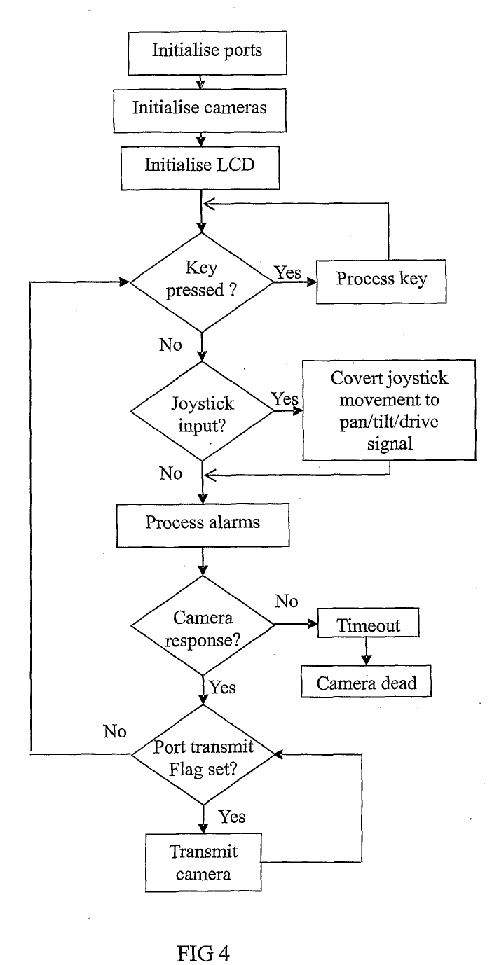

It will be appreciated from the above discussion that the controller operates according to the programme stored in the EEPROM 12. The flowchart of FIG. 4 provides a summary of the operating steps. As shown in FIG. 4, the ports, cameras and LCD are initialized. This occurs at boot up or each time there is a configuration change.

The main programme loop, as depicted in FIG. 4, then checks for any keys pressed. This is done by a module that scans the keypad 4 and sets a variable with the value of any key pressed. The key press is processed and then loops for the next key press. If there are no further keys pressed within a poll period the loop steps to the joystick module. If there is input from either joystick the joystick module converts the analogue values into meaningful scaled values that will be transmitted to a camera.

Next any alarms are processed and the camera response checked. If a camera does not respond after a suitable timeout it is flagged as dead. If a camera is active the transmit lag on the relevant port is checked and instructions are transmitted to the camera on the relevant port to move, pan, tilt, etc. The process then repeats.

Throughout the specification the aim has been to describe the invention without limiting the invention to any particular combination of alternate features.

1. A controller for a video surveillance system having multiple cameras, the controller comprising:
at least two joysticks, each joystick having at least two-axis control;
a keypad;
one or more output ports in communication with two or more cameras; and
a processor receiving input signals from said keypad and said at least two joysticks and sending output signals to at least one of said one or more output ports to control two of said multiple cameras simultaneously.

2. The controller of claim 1 wherein each joystick controls the function of pan and tilt of one of two of said multiple cameras.

3. The controller of claim 1 wherein each joystick is a three-axis joystick.

4. The controller of claim 3 wherein movement of the joystick is translated to control pan, tilt and drive of one of the two of said multiple cameras.

5. The controller of claim 1 wherein each joystick is a four-axis joystick.

6. The controller of claim 5 wherein movement of the joystick is translated to control the functions of pan, tilt, zoom and drive of one of two of said multiple cameras.

7. The controller of claim 1 further comprising one or more communication protocols, each output port being configured for a communications protocol suitable for video cameras in communication with the port.

8. The controller of claim 1 further comprising storage means that stores one or more default positions and views for each camera.

9. The controller of claim 1 further comprising a display screen.

10. The controller of claim 1 further comprising one or more alarm ports.

11. The controller of claim 1 further comprising an external interface system.

12. The controller of claim 1 further comprising multiple output ports in addition to the one or more output ports, and the multiple output ports are configurable as alarm ports or external interface ports.

13. The controller of claim 1 wherein the processor includes instructions to position each non-active camera at a default position and view determined by which of the multiple cameras are actively controlled by the joysticks.

14. The controller of claim 1 wherein the processor includes instructions to automatically move one or more cameras according to a pre-set tour.

15. The controller of claim 1 wherein the processor includes instructions activated by the keypad to configure the joysticks and keys on the keypad.

16. The controller of claim 1 wherein the keypad selects one or more functions selected from: selecting an active camera; selecting an active monitor; set-up of the controller; and set-up of default camera positions.

17. The controller of claim 1 wherein the keypad adjusts operating parameters of the cameras.

18. The controller of claim 17 wherein the operating parameters include zoom, focus and iris.

19. A video surveillance system comprising:
multiple cameras;
one or more monitors; and
a controller comprising:
at least two joysticks, each joystick having at least two-axis control;
a keypad;
one or more output ports in communication with the two or more cameras; and
a processor receiving input signals from said keypad and said at least two joysticks and sending output signals to at least one of said one or more output ports to control two of said multiple cameras simultaneously.

20. The video surveillance system of claim 19 wherein the processor includes instructions to position each non-active camera at a default position and view determined by which of the multiple cameras are actively controlled by the joysticks.

21. The video surveillance system of claim 19 wherein the processor includes instructions to automatically move one or more cameras according to a pre-set tour.

22. The video surveillance system of claim 19 wherein the processor includes instructions to automatically change cameras actively controlled by the joysticks.
